(19) United States
(12) Patent Application Publication
(10) Pub. No.: US 2024/0228070 A1
(43) Pub. Date: Jul. 11, 2024

(54) ROTARY-RING SEPARATION DEVICE AND METHOD

(71) Applicant: Stardust Holdings, LLC d/b/a/XTERRA Space, Austin, TX (US)

(72) Inventors: Alex Amelia Kuehn, Austin, TX (US); Tyler Gerald Holden, Bastrop, TX (US)

(21) Appl. No.: 18/407,967

(22) Filed: Jan. 9, 2024

Related U.S. Application Data
(60) Provisional application No. 63/437,978, filed on Jan. 9, 2023.

(51) Int. Cl. B64G 1/64

(52) U.S. Cl. CPC B64G 1/645

(57) ABSTRACT

This disclosure relates generally to a reusable separation device utilizing a rotary ring and at least one actuator to release a plurality of mechanisms simultaneously to evenly distribute the load experienced by the system and gain mechanical advantage in a low-profile, low-cost system for holding and releasing an object. The apparatus of the invention is particularly useful for spacecraft and other vehicular separation devices.

### CROSS-REFERENCE TO RELATED APPLICATIONS

The present application claims the benefit of U.S. Provisional Application No. 63/437,978, filed Jan. 9, 2023; all of which is incorporated herein in its entirety and referenced hereto.

### FIELD OF THE INVENTION

This disclosure relates generally to a reusable separation device utilizing a rotary ring and at least one actuator to release a plurality of mechanisms simultaneously to evenly distribute the load experienced by the system and gain mechanical advantage in a low-profile, low-cost system for holding and releasing an object.

### BACKGROUND OF THE INVENTION

Underwater vehicles, aircraft, launch vehicles and spacecraft have long required specialized separation devices for various situations. For example, aircraft require separation devices for the release of bombs or fuel tanks, launch vehicles require actuating devices for separating rocket stages or payloads and spacecraft require separation devices for releasing solar arrays or antennas amongst other things.

Many separation devices have been utilized over the years, but they all have a variety of shortcomings. The paradox of separation devices for space applications is that they must be high load carrying, yet light weight, as well as fast acting, but low shock. For example, clamp bands have been utilized but have the shortcoming of generating large shock forces. They also inherently need to be designed to operate near their structural limit since they are significantly pre-strained before flight loading, and are difficult to design since you must anticipate how they will deform. Another system known as the light-band, see U.S. Pat. Nos. 6,227,493; 6,343,770; 6,390,416, utilizes a band in compression along with hinged members to hold the fly-away ring and is released by allowing the ring to buckle, and while this is a lightweight solution, it has the shortcoming of being very mechanically complex in addition to having similar design complexity to clamp bands since it also relies on intentionally deforming structural elements. There are also separation devices which use a large ball-lock type mechanism, but this has the shortcoming of being impractical to design for high load carrying capability due to the hertzian contact stress present in such a mechanism. There are also separation devices which use what is sometimes referred to as a multi-point release by utilizing multiple fast acting actuators such as fuse wire release mechanisms. These have the shortcoming though of needing a high quantity of actuators to achieve comparable stiffness to a clamp band or light-band and while they are more mechanically simple, they're more electrically complex, and are reliant on high simultaneity actuators which are often expensive, single use, and heavy.

The disclosed subject matter helps to avoid these and other problems.

### SUMMARY OF THE INVENTION

This disclosure relates generally to a reusable separation device utilizing a rotary ring and at least one actuator to release a plurality of mechanisms simultaneously to evenly distribute the loads experienced by the system and gain mechanical advantage in a low-profile, low-cost system for holding and releasing an object.

The main advantage of using the invention is the provision for a novel means of utilizing a single actuator to initiate a simultaneous release of multiple mechanical mechanisms in a separation system which is a lightweight and low-profile solution that can be readily adapted to a variety of applications.

### DETAILED DESCRIPTION OF THE INVENTION

The inventive device utilizes the combination of at least two elements, with release mechanisms, and a rotatory ring collated with at least one actuator on one of the two elements.

When power is applied to the actuator it allows the rotary ring to rotate, removing an interference fit between the ring and the mechanisms collocated on one of the elements, allowing the mechanisms to all release simultaneously, and mechanically separating the two elements.

Additionally, staging mechanisms between the actuator and the rotator ring may be used to increase mechanical advantage.

Additionally, the release mechanisms may also utilize staging mechanisms to increase mechanical advantage.

Additionally, separation springs may be included to impart a delta velocity between the two elements once the mechanisms have released.

Additionally, these separation springs alone or in addition to other springs may be utilized to articulate the release mechanisms once the interference of the rotary ring is removed.

Utilization of the combination of at least two load bearing elements, with release mechanisms, and a rotatory ring collated with at least one actuator on one of the two elements provides the following advantages: 1. A means of simultaneously releasing a plurality of mechanical mechanisms with a single actuator, 2. A lightweight device of minimum part count, 4. A low profile and uniquely shaped separation device.

Some applications of the separation device include submarine torpedo release, submarine door release, and underwater cable release. Some aviation applications are bomb release, fuel tank release, parachute release, and safety device release. Some launch vehicle applications include rocket stage separation, payload separation and landing gear release. Some spacecraft applications include solar array release and antenna release amongst other things.

### BRIEF DESCRIPTION OF THE DRAWINGS

A more complete understanding of the invention and the many attendant advantages thereof will be readily appreciated as the same becomes better understood by reference to the following detailed description, when considered in connection with the accompanying drawings wherein:

FIG. 1a is a top-down isometric view of the first embodiment while static.

FIG. 1b is a top-down isometric view of the first embodiment once released.

FIG. 1c is a bottom-up isometric view of the first embodiment while static.

FIG. 1d is a bottom-up isometric view of the first embodiment once released.

FIG. 2a is an isometric cutaway view of the of the first embodiment while static.

FIG. 2b is an isometric cutaway view of the of the first embodiment once released.

FIG. 3a is a cutaway view of the of the first embodiment while static.

FIG. 3b is a cutaway view of the of the first embodiment once released.

FIG. 4a is a detailed view of the bottom of the first embodiment while static.

FIG. 4b is a detailed view of the bottom of the first embodiment while static with the rotatory ring excluded to show the internal mechanism.

FIG. 4c is a detailed view of the bottom of the first embodiment once released.

FIG. 4d is a detailed view of the bottom of the first embodiment once released with the rotatory ring excluded to show the internal mechanism.

### DESCRIPTION OF THE PREFERRED EMBODIMENT

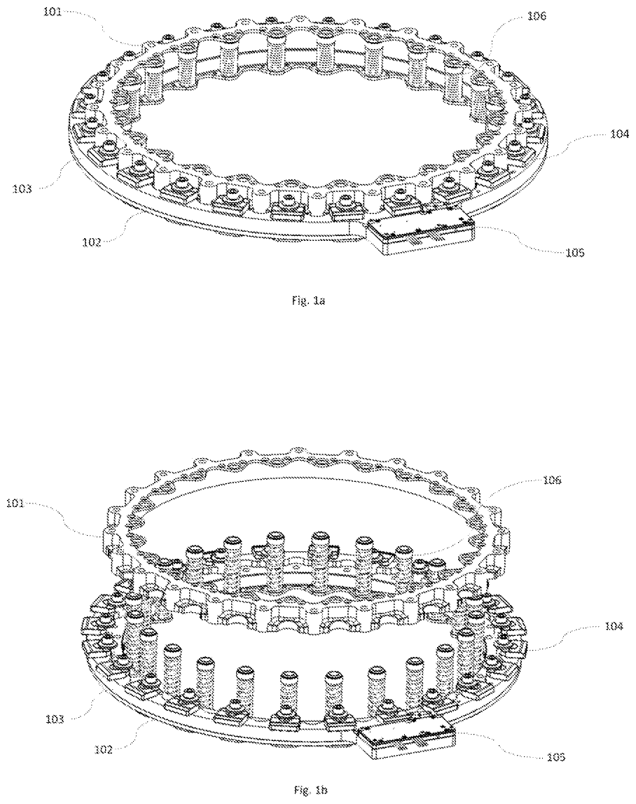

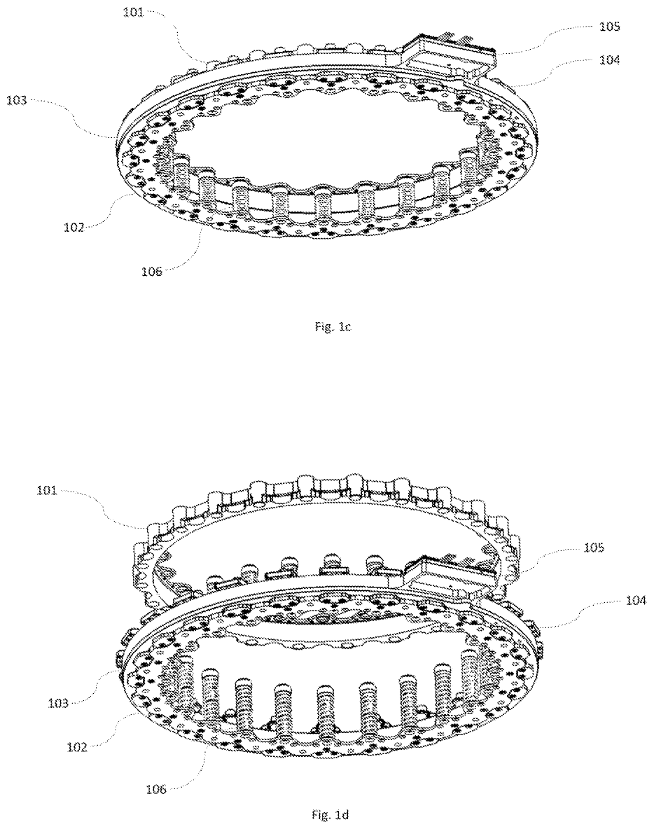

In FIG. 1a the inventive device utilizes actuator 105 to hold back rotary-ring 102 from rotating, stopping release mechanisms 104, all collated on stay-behind member 103 from allowing separation mechanisms 106 from separating fly-away member 101 from stay-behind member 103.

In FIG. 1b actuator 105 has been actuated, allowing rotary-ring 102 to rotate, allowing separation mechanisms 106 to push release mechanisms 104 out of the way and separate fly-away member 101 from stay-behind member 103.

In FIG. 1c the inventive device utilizes actuator 105 to hold back rotary-ring 102 from rotating, stopping release mechanisms 104, all collated on stay-behind member 103 from allowing separation mechanisms 106 from separating fly-away member 101 from stay-behind member 103.

In FIG. 1d actuator 105 has been actuated, allowing rotary-ring 102 to rotate, allowing separation mechanisms 106 to push release mechanisms 104 out of the way and separate fly-away member 101 from stay-behind member 103.

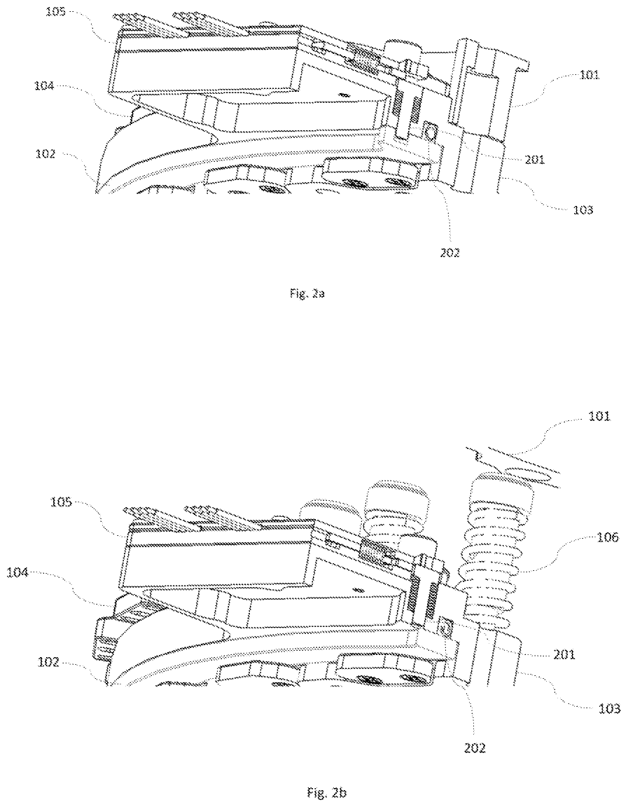

In FIG. 2a the inventive device utilizes actuator 105 to hold back rotary-ring retention pin 201, which holds back rotatory-ring 102 from being rotated by springs 202, which holds back release mechanisms 104 from allowing fly-away member 101 from separating from stay-behind member 103.

In FIG. 2b actuator 105 has actuated, allowing rotary-ring retention pin 201 to retract, which allows springs 202 to cause rotary-ring 102 to rotate, allowing separation mechanisms 106 to push release mechanisms 104 out of the way, allowing fly-away member 101 to separate from stay-behind member 103.

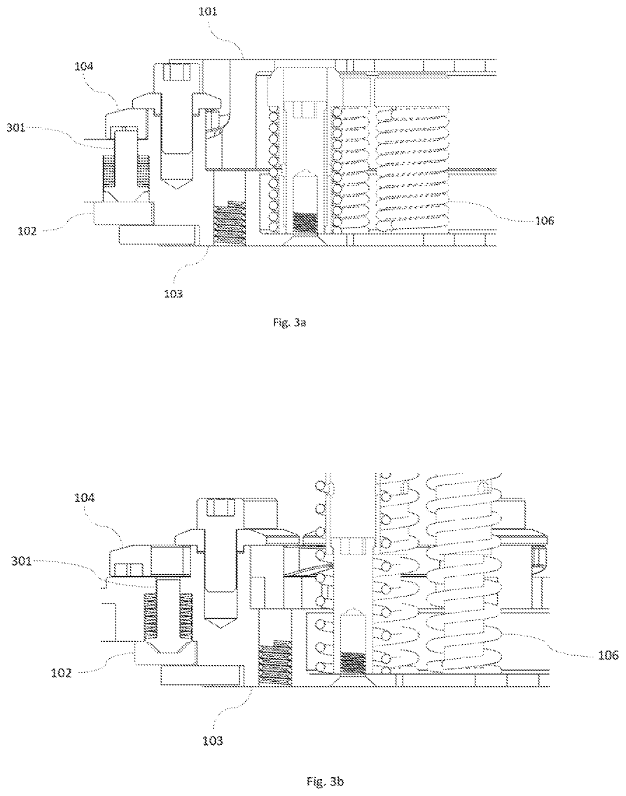

In FIG. 3a the inventive device utilizes rotary-ring 102 to hold back release mechanism retention pin 301, which holds back release mechanism 104 from being pushed out of the way by separation mechanisms 106 pushing on fly-away member 101, keeping fly-away member 101 from separating from stay-behind member 103.

In FIG. 3b rotary-ring 102 has rotated, allowing release mechanism retention pin 301 to retract, allowing release mechanism 104 to be pushed out of the way by separation mechanisms 106 pushing on fly-away member 101, allowing fly-away member 101 to separate from stay-behind member 103.

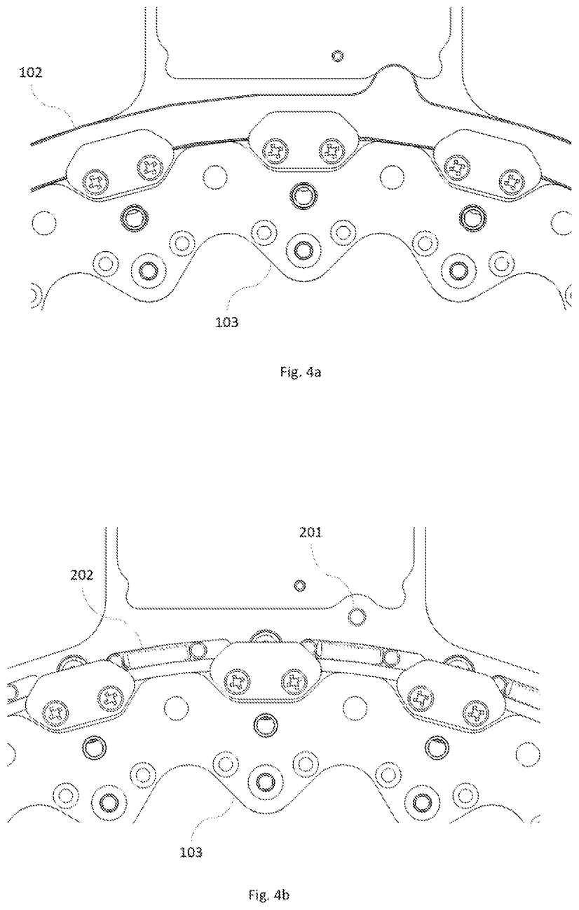

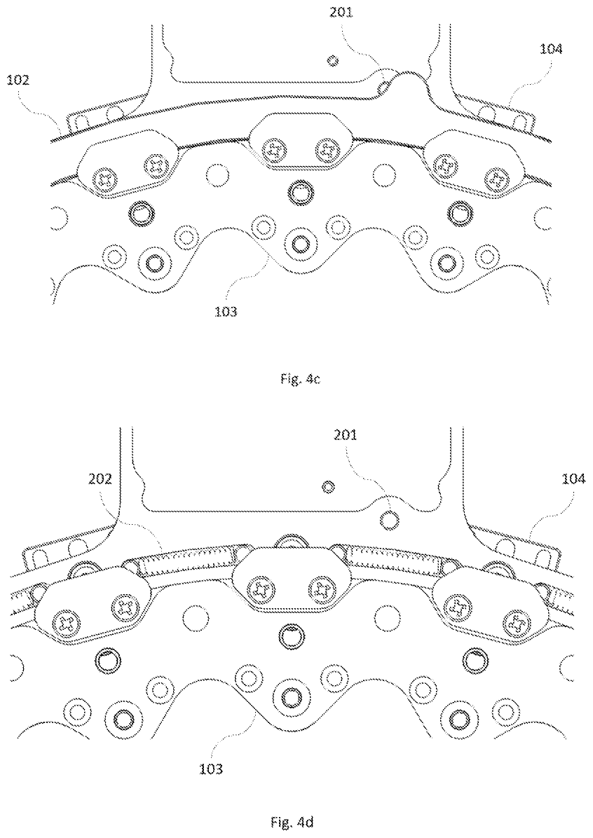

In FIG. 4a the inventive device utilizes rotary-ring 102 collocated on stay-behind member 103 to stop fly-away member 101 (not shown) from separating from stay-behind member 103.

In FIG. 4b rotary-ring 102 has been hidden to show springs 202 trying to rotate rotary-ring 102 (not shown) being held back by rotary-ring retention pin 201.

In FIG. 4c rotary-ring retention pin 201 has retracted, allowing rotary-ring 102 to rotate, allowing release mechanisms 104 to be pushed out of the way by separation mechanisms 106 (not shown) pushing on fly-away member 101 (not shown), allowing flyaway member 101 (not shown) to separate from stay-behind member 103.

In FIG. 4d rotary-ring retention pin 201 has retracted, allowing springs 202 to rotate rotary-ring 102 (not shown), allowing release mechanisms 104 to be pushed out of the way by separation mechanisms 106 (not shown) pushing on fly-away member 101 (not shown), allowing fly-away member 101 (not shown) to separate from stay-behind member 103.

The inventive device enables the creation a separation device utilizing a single actuator 105 to initiate a simultaneous release of multiple mechanical mechanisms 104, 106, 201, 301 by rotating a rotary ring 102 in a separation system which is a lightweight and low-profile solution that can be readily adapted to a variety of applications.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A rotary ring separation device, comprising:
a first element;
a second element;
a rotary ring;
an actuator; and
a plurality of mechanisms;
wherein said rotary ring, said actuator, and said plurality of mechanisms are mounted on said first element, wherein said second element releasably connects to said first element, and wherein said actuator causes said rotary ring to rotate and allow said plurality of mechanisms to release said second element.

2. (canceled)

3. The rotary ring separation device of claim 1, wherein said plurality of mechanisms comprises release mechanisms and separation mechanisms.

4. The rotary ring separation device of claim 3, wherein said release mechanisms and said separation mechanisms hold said second element in place prior to actuation of said actuator.

5. The rotary ring separation device of claim 1, wherein power is applied to said actuator causing said rotary ring to rotate and remove an interference fit between said rotary ring and said plurality of mechanisms collocated on said first element.

6. The rotary ring separation device of claim 5, wherein said plurality of mechanisms release simultaneously and mechanically separate said first element and said second element.

7. The rotary ring separation device of claim 1, wherein said actuator and said rotary ring utilize a staging mechanism to increase mechanism advantage.

8. The rotary ring separation device of claim 1, wherein said plurality of mechanisms utilize a staging mechanism to increase mechanism advantage.

9. The rotary ring separation device of claim 1, wherein said actuator comprises a rotary ring retention pin holding back said rotary ring.

10. The rotary ring separation device of claim 9, further comprises springs, wherein said actuator holds back said rotary ring retention pin holding back said rotary ring from being rotated by said springs, and wherein said springs hold back said plurality of mechanisms.

11. The rotary ring separation device of claim 10, wherein said actuator actuates allowing said rotary ring retention pin to retract, which allows said springs to cause said rotary ring to rotate to allow plurality of mechanisms to release said second element.

12. The rotary ring separation device of claim 3, wherein said release mechanisms comprise release mechanism retention pins, and wherein said release mechanism retention pins hold said release mechanisms from being pushed by said separation mechanisms.

13. The rotary ring separation device of claim 12, wherein said actuator causes said rotary ring to rotate allowing said release mechanism retention pins to retract, which allow said release mechanisms to be pushed by said separation mechanisms for releasing said second element.

14. A rotary ring separation device, comprising:
a first element;
a second element;
a rotary ring;
an actuator;
a release mechanism; and
a separation mechanism,
wherein said rotary ring, said actuator, said release mechanism and said separation mechanism are mounted on said first element, wherein said second element releasably connects to said first element, and wherein said actuator causes said rotary ring to rotate to allow said separation mechanism to push said release mechanism for releasing said second element from said first element.

15. The rotary ring separation device of claim 14, wherein power is applied to said actuator causing said rotary ring to rotate and remove an interference fit between said rotary ring, and said release mechanism and said separation mechanism collocated on said first element.

16. The rotary ring separation device of claim 14, wherein said actuator and said rotary ring utilize a staging mechanism to increase mechanism advantage.

17. The rotary ring separation device of claim 14, wherein said release mechanism and said separation mechanism utilize a staging mechanism to increase mechanism advantage.

18. The rotary ring separation device of claim 14, wherein said actuator comprises a rotary ring retention pin holding back said rotary ring, wherein said rotary ring separation device comprises springs, wherein said actuator holds back said rotary-ring retention pin holding back said rotary ring from being rotated by said springs, and wherein said springs hold back said release mechanism and said separation mechanism.

19. The rotary ring separation device of claim 18, wherein said actuator actuates allowing said rotary ring retention pin to retract, which allows said springs to cause said rotary ring to rotate to allow said release mechanism and said separation mechanism to release said second element.

20. The rotary ring separation device of claim 14, wherein said release mechanism comprises a release mechanism retention pin, wherein said release mechanism retention pin holds said release mechanism from being pushed by said separation mechanism, and wherein said actuator causes said rotary ring to rotate allowing said release mechanism retention pin to retract, which allows said release mechanism to be pushed by said separation mechanism for releasing said second element.

21. A method of providing a simultaneous mechanical release function in a rotary ring separation device, said method comprising the step of:
providing a first element and a second element, said second element releasably connecting said first element;
providing a rotary ring, an actuator and a plurality of mechanisms on said first element; and
actuating said actuator for causing said rotary ring to rotate and allow said plurality of mechanisms to release said second element.
